(19) United States
(12) Patent Application Publication
(10) Pub. No.: US 2005/0196502 A1
(43) Pub. Date: Sep. 8, 2005

(54) Extrudate cutting device

(75) Inventors: David Alexander, Wodonga (AU); Kevin Rees, Wodonga (AU); John Karslake, Wodonga (AU); Paul Lempriere, Wodonga (AU)

Correspondence Address: FULBRIGHT & JAWORSKI, LLP, 1301 MCKINNEY, SUITE 5100, HOUSTON, TX, 77010-3095, US

(73) Assignee: MARS INCORPORATED, McLean, VA (US)

(21) Appl. No.: 10/929,055

(22) Filed: Aug. 27, 2004

(30) Foreign Application Priority Data
Mar. 2, 2004 (AU) 2004901052

(51) Int. Cl. A23G 1/00

(52) U.S. Cl. 426/518

(57) ABSTRACT

A method of producing a textured proteinaceous meat analogue, with an optimized fibrous appearance, from an extrudate which passes through a conduit of known cross-sectional shape, said method including the steps of: determining a cutting profile for said extrudate, said profile including the making of a slice through the extrudate that is substantially co-linear with the longest axis of said cross-sectional shape; and slicing through said extrudate, via one or more blades adapted to slice in a manner according to the above determined profile, in a direction substantially opposed to the direction of flow of the extrudate through, or exiting, said conduit.

### CROSS-REFERENCE TO RELATED APPLICATIONS

This application claims priority to Australian Application No. 2004901052 filed Mar. 2, 2004.

### TECHNICAL FIELD

The invention relates generally to food products. More specifically, the invention relates to a method and apparatus for the production of a proteinaceous meat analogue having a meat-like appearance, and products so produced.

### BACKGROUND OF THE INVENTION

The industrial manufacture of meat analogue products from protein-rich precursor materials, including plant based precursors such as cereal grain gluten (of wheat, rice, or maize; whether vital or with residual starch), defatted oil seed, cereal and bean flours, meals and derivatives (e.g. defatted soy flour, soy protein concentrate, wheat flour), or animal based precursors such as meat by-products obtained by mechanical separation, fish meal, dried egg white and others, alone or in combination, is nowadays well established practice (hereinafter also simply referred to as texturized protein products (or TPP's)).

Cooking-extrusion technology is by far the most widely used of the different possible manufacturing methods to obtain such meat analogues. In its very basic form, manufacture of meat analogue products with a textured or fibrous structure entails the commingling of the weighted dry precursors and introducing these together with water (to obtain a desired moisture content in the mixture) into a suitable heated extruder (e.g. single or double screw extruder). Whilst passing through the extruder, which has discrete sections to perform specific mechanical operations on the mixture, the mixture is plasticized and heated to form a hot, viscous and at least partly molten mass, often referred to as protein lava. The properties of the viscous mass at the end of the thermo-mechanical conversion process, which the pre-cursors undergo within the extruder barrel, are dependant on the process variables (eg. temperature in the different sections of the extruder barrel, screw speed/barrel section pressure, moisture content, precursor formulation, etc). The viscous mass of proteinaceous material may be passed through a breaker plate having a multitude of small openings, to equalize the pressure across the screw outlet. In many applications, the material is passed through a forming die, which is shaped to produce the desired size and shape chunks. A rotary cutter or the like is normally used to cut the extrudate ‘strings’ exiting each die, to produce the final chunk size. This technology is described in detail by Harper, in “Extrusion of Foods”, (1981) CRC Press, Volume 2, p 95-99.

High moisture extrusion-cooking and texturization (HMEC) is a technology that has been successfully employed in recent years in fibrating protein-based formulations at high moisture content, and thus texturizing “wet”, meat-like TPP's either using solely plant protein sources (cereal and oil-seed grain protein sources such as soya flour, soy protein concentrate and vital wheat gluten, in particular) and/or animal proteins such as fish flour, egg white powder, fresh meat by-products and the like. Patent document no. WO 00/69276 by Effem Foods Pty Ltd discloses an application of this technology, using a modified hammer-mill to effect the exposure of meat-like, or fish-like, internal extrudate texture.

Another technology for making meat-like analogues is that disclosed in WIPO Patent Document No. WO 01/35766, which discloses a meat emulsion product with meat-like fiber formation, obtained from rapid heating of a proteinaceous meat emulsion which is subjected to high pressure and formed through an elongated tube. Traditional cutting methods such as a rotary knife, water-jet cutting, a knife-grid or the like may be mounted at the discharge end of the tube to cut the product into pieces of the desired size. A method of enhancing appearance by a secondary size reduction step by using compression rolls is also disclosed in that document.

The texture of all such products, whether based solely on grain or bean sourced proteins or having additional, meat based precursors is an especially important criteria if such product is to be used as a replacement for real meat products, as acceptance of the product will depend on its capability to simulate the appearance of meat.

Therefore, various methods have been developed for the cutting and/or shredding of the extrudate, mostly involving rotating cutters that slice laterally across the extrudate stream as it exits the extrusion equipment. This tends to expose the internal texture of the extrudate material only at the front and rear ends of the cut piece, which may be sufficient in some applications.

However, where it is desired that the extruded food material displays the fibrous texture of meat or fish, it is preferred that as much of the internal fibrous extrudate material is exposed as possible. The modified hammer-mill disclosed in the above-mentioned WO 00/69276 tends to effect maximum exposure of meat-like, or fish-like, internal extrudate texture. This technique tends to create a wide range of particle sizes, and highly random shapes, and so finds particular use for creating extrudate pieces that are to resemble randomly shredded meat, chicken or fish products. Conversely, this technique does not find favour where the extrudate is to emulate sliced or diced meat products, due to the difference in particle shapes required for authenticity, and the potentially high level of ‘fines’ which can spoil the appearance of the product.

### BRIEF SUMMARY OF THE INVENTION

It is an object of the present invention to provide a method and device for the controlled slicing of proteinaceous meat analogues, which optimizes the ‘meat-like’ appearance of said meat analogue pieces.

According to one aspect of the invention, there is provided a method of producing a textured proteinaceous meat analogue, with an optimized fibrous appearance, from an extrudate which passes through a conduit of known cross-sectional shape, said method including the steps of: determining a cutting profile for said extrudate, said profile including the making of a slice through the extrudate that is substantially co-linear with the longest axis of said cross-sectional shape; and slicing through said extrudate, via one or more blades adapted to slice in a manner according to the above determined profile, in a direction substantially opposed to the direction of flow of the extrudate through, or exiting, said conduit.

The appearance of laminations in the internal structure of extruded proteinaceous materials, which are perceived to provide the meat-like texture, are an artifact of the conditions in which the extrudate is formed. Due to the unequal linear flow rate of extrudate across the cross-section of a conduit passing through the extruder die plate, cooling die or the like, the texture will form with a distinct grain as it solidifies, depending on the rheology of the molten extrudate mass.

Typically, the laminations will form in a parabolic shape through the extrudate, along an axis substantially parallel with the direction of flow. As the grain profile is more elongated across a longer dimension of the cross-sectional shape of the extrudate, so the grain profile will tend to appear more as parallel (as opposed to parabolic) aligned fibers through the material. As this parallel fiber effect is most important in producing an authentic meaty appearance, slices made through the longer dimension of the extrudate, in the same orientation as the axial direction of flow of the extrudate through the conduit.

In addition, where the surface area of exposed internal structure is maximized relative to the volume of the extrudate, a significantly improved analogue appearance is obtained, as compared with cutting across the grain, per the prior art. This method further provides optimized fibrous appearance without the generation of excess fines associated with other prior art methods, eg where final size reduction is completed as a secondary stage such as hammer-milling, compression rolls or the like.

For example, where the cross-sectional shape of said conduit is substantially oblong, it is preferred that the cutting profile is determined such that at least one blade slices through the extrudate in an orientation that is substantially parallel with the longest dimension of said oblong shape.

In a particularly preferred embodiment, where the cross-sectional shape of said conduit is substantially a rectangle having one dimension greater than five times that of the other dimension, it is preferred that said cutting profile includes at least one blade to slice through the extrudate in a profile that is substantially parallel with the longer of the extrudate cross-sectional dimensions.

In an alternative embodiment, where the cross-sectional shape of said conduit is substantially circular, it is preferred that said cutting profile includes the making of at least one circular slice substantially concentric with said cross-sectional shape.

The above described method tends to be best carried into effect where the extrudate is substantially solidified when coming into contact with the blades. Therefore, it would be advantageous to further include the step of cooling the extrudate, whether via a cooling die or other means, prior to the slicing step.

In another aspect, the invention provides a cutting device for slicing a textured proteinaceous meat analogue, adapted to the cutting profile determined as defined above.

In another aspect, the invention provides a production facility for manufacturing food products incorporating a cutting device according to any described above.

In another aspect, the invention provides a food product incorporating a textured proteinaceous meat analogue, said analogue being produced by a method according to any described above.

The embodiments of the invention described above may be utilized on their own for the production of a meat analogue piece, or alternatively in conjunction with a conventional cutting system, such as a rotary cross-cut system of the type commonly used at the outlet of extrusion cooking systems, in order to produce the desired product appearance, or via other fixed blades provided purely to produce a particularly sized analogue piece.

It will also be appreciated by those skilled in the art that the precise location of the cutting device according to the invention may be varied to suit the operation, the only limitation being that it be placed in the system post-formation of the internal grain structure.

In another aspect of the invention, there is provided a food extrusion system incorporating a food extrudate cutting device as defined above.

In another aspect of the invention, there is provided a sliced food extrudate ribbon wherein the slicing has been carried out via a food extrudate cutting device as defined above.

### BRIEF DESCRIPTION OF THE DRAWINGS

Now will be described, by way of a specific, non-limiting example, a food extrudate cutting device according to the invention.

FIG. 1 is an illustrative schematic perspective view of an extrudate ribbon which has been partly sliced by a laterally oriented blade, in a manner illustrating the prior art.

FIG. 2 is an illustrative schematic perspective view of an extrudate ribbon which has been partly sliced by a longitudinally mounted blade according to the invention.

FIG. 3 is an illustrative schematic perspective view of extrudate which is substantially circular in cross-section and which has been partly sliced through its diameter by a mounted blade, according to the prior art.

FIG. 4 is an illustrative schematic perspective view of extrudate which is substantially circular in cross-section and which has been partly sliced through its diameter by a mounted blade, and which has been partly sliced through its centre by a circular blade according to alternative embodiment of the invention.

FIG. 5 is an end view of a cutting device according to the invention.

FIG. 6 is an end view of an alternative cutting device according to the invention.

FIG. 7 is a representation of a ‘wafu steak’ variety of extrudate pieces that can be produced according to the invention.

FIG. 8 is a representation of an alternative ‘stir fry’ variety of extrudate piece that can be produced according to the invention.

### DETAILED DESCRIPTION OF THE INVENTION

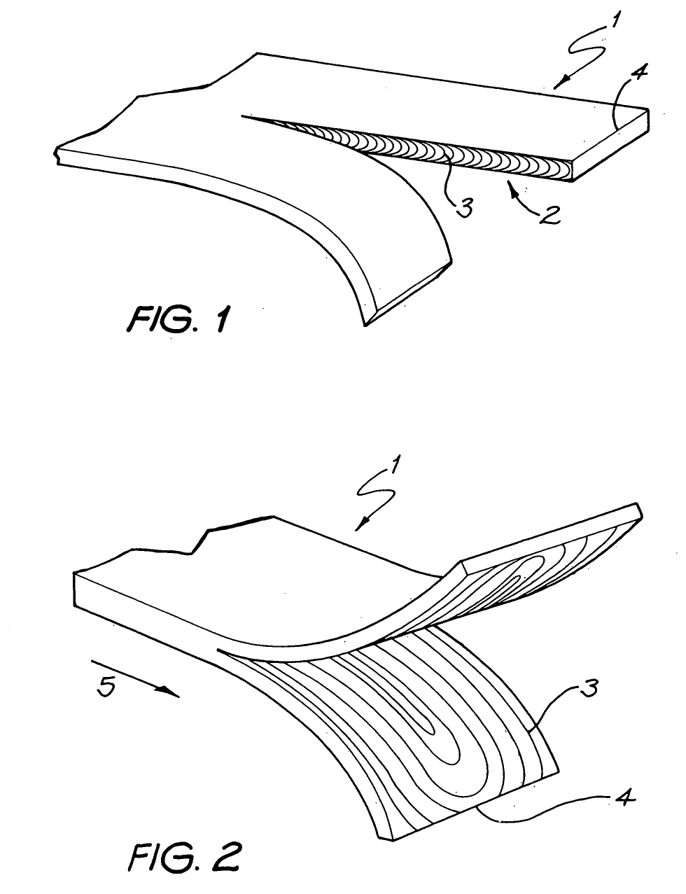

Turning first to FIG. 1, there is shown a proteinaceous meat analogue extrudate ribbon which has been partly sliced by a laterally oriented blade. It will be observed that the area of exposed internal lamination is quite small relative to the overall size of the ribbon, and particularly this view shows the exposed grain is in a non-optimal manner. It will be observed that the exposed grain displays a ‘parabolic’ profile, which appears ‘manufactured’, and which fails to aesthetically capitalize on the substantially parallel grain alignment which exists along the longer dimension of the ribbon. Accordingly, the visual or aesthetic benefit of the creation of this internal structure is not realized when including the extrudate sliced in this manner into a food product.

Illustrated clearly in FIG. 2 is the aesthetic benefit of selecting a cutting profile template that causes both optimum exposure of the internal structures and which targets the part of the ribbon where the internal grain is formed substantially parallel with the direction of flow of the ribbon and with the wider surface of the ribbon: a far greater surface area being exposed in total, and crucially the exposure of the more authentically textured meat-like laminations is optimized. The key to providing this advantage for all shaped extrudates is in the inventive step of analyzing and deciding precisely which cutter configuration will so optimize this effect: typically being at least one blade being positioned to slice through the longest dimension of the ribbon in the direction of flow of the ribbon out of the conduit in which it has been formed, thereby to expose the grain of the lamination at an area where it is substantially parallel with the surface of the ribbon.

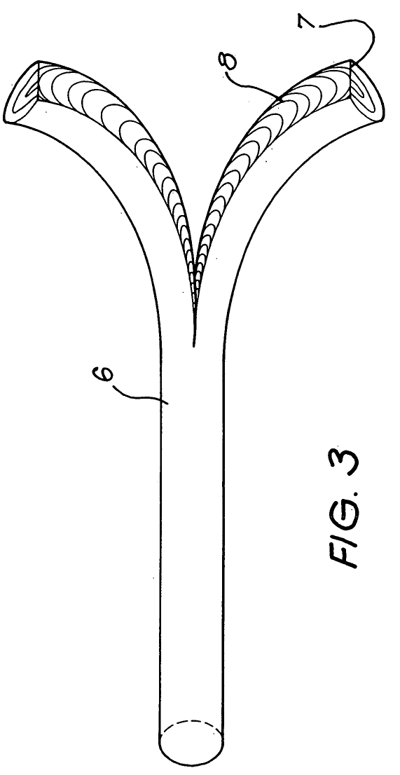

In this regard, FIG. 3 illustrates an approach to the slicing of a relatively cylindrical extrudate which provides a partial, but non-optimal, solution to the issue of texture optimization: the single slice is provided through the diameter of the cylinder, thereby maximizing the internal structure which can be exposed via a single straight cut.

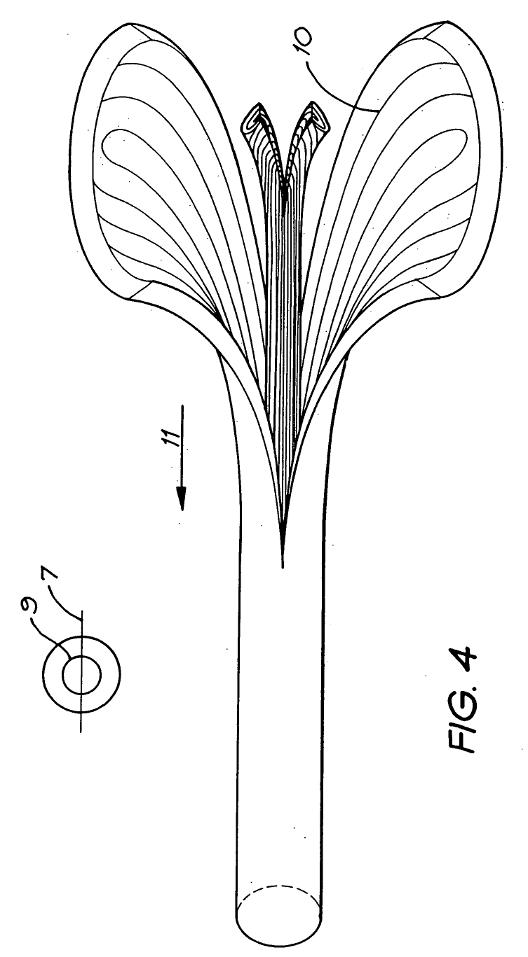

However, the template illustrated in FIG. 4 provides the optimized cutting profile, by additionally providing a circular cut though the centre of the cylinder. This further cut can be seen to greatly enhance the exposure of the internal structure through a section where the internal grain is substantially parallel with the cut direction, producing an optimized appearance.

It will be appreciated by the person skilled in the art that a variety of templates may be provided for each extrudate cutting task, practically constrained mainly by the size and shape of the extrudate, the desired dimensions of the cut analogue (with particular regard to the minimum desired thickness of the analogue, as regards both aesthetics and the physical robustness of the analogue), while remaining within the spirit and scope of the invention.

In particular, the practical selection of the appropriate cutting template might proceed as follows:
select the minimum permissible cut analogue thickness, with regard to aesthetic considerations and to the level of robustness required to withstand subsequent processing;
determine by geometric analysis of the known cross-section of the extrudate the maximum capacity of said extrudate to yield a continuous ribbon of extrudate of thickness determined above, and therefore the shape of cut which will be required to produce such ribbon;
design one or more fixed blades which comprise a cutting device that can most approximately produce the cut determined above;
install the cutting device into the food extrusion system so that the blades effectively cut substantially parallel with the likely internal grain formation of the ribbon.

Now will be described two examples of food product manufacture that include optimized proteinaceous meat analogue chunks according to the invention.

### EXAMPLE 1

### ‘Wafu Steak’ Slices

A proteinaceous extrudate designed to resemble muscle meat is to be produced. The formulation of the extrudate, and the extruder and cooling die are substantially similar to those disclosed in Patent document no. WO 00/69276 by Effem Foods Pty Ltd. The proteinaceous meat analogue chunks have been produced via a food extrusion system which is as described therein, and according to the formulation as described therein.

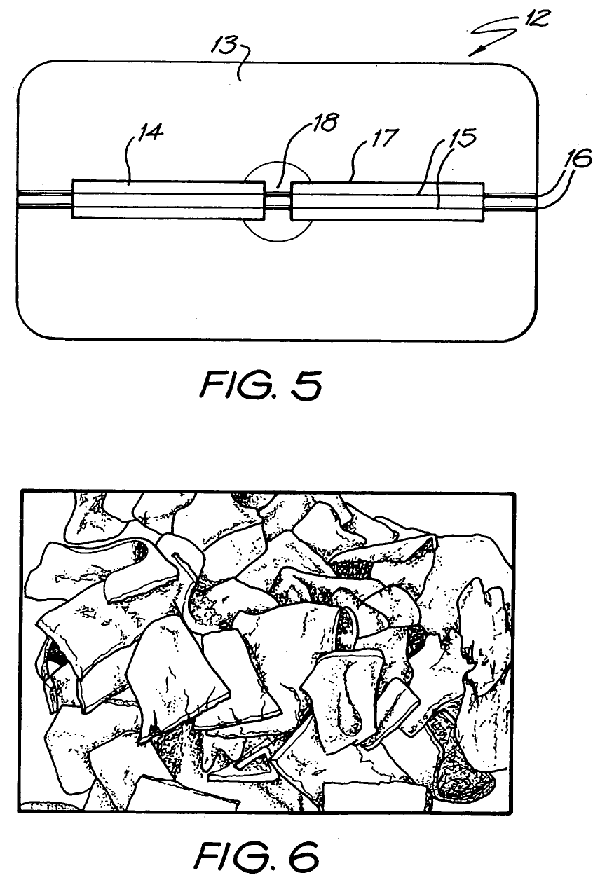

In this example, a cutting device according to the invention, and illustrated in FIG. 5, has been mounted across the outlet of the cooling die. The cutting device consists of a steel mounting plate, having an orifice corresponding in dimension approximately with the outlet orifice of the cooling die: 70 mm by 7 mm. Spanning this orifice are steel blades that are mounted in cross-slots machined into the periphery of the orifice.

The blades are mounted in form-fitting manner such that the cutting edges of the blades face toward the direction of flow of extrudate, represented by the arrow, thereby to cut the extrudate ribbon into individual slices as it passes through the cutting device.

With regard to the cutting template, application of the inventive method to the blade design suggests that for the elongate rectangular cross-sectional shape of the outlet orifice, it will be optimal to arrange at least one blade longitudinally across the longest dimension of the orifice, in a direction substantially parallel with the longer edge. As the requirement here is for particularly thin slices, a cutting template was chosen such that there are two blades which span the longer dimension of the orifice, effectively trisecting it in order to slice a 7 mm thick ribbon into three equal slices of 2.3 mm thickness. In order to meet further overall sizing objectives, there is also a single blade which spans across the shorter dimension of the orifice, effectively bisecting it in order to slice a 70 mm wide ribbon into two equal widths, 35 mm wide.

In this manner are produced thin ‘wafu steak’ style slices of meat analogue 2.3 mm thick and 35 mm wide. For this particular case, a conventional rotary cutter is then employed to produce lengths of approximately 40 mm.

The meat analogues so produced have on at least one surface a strong resemblance to muscle meat, due particularly to the selection of the longitudinal slices through the thinner dimension of the extrudate ribbon (where the internal grain is seen to be effectively parallel with the cut) and due to the fact that this cut is made substantially opposed to direction of flow of the extrudate.

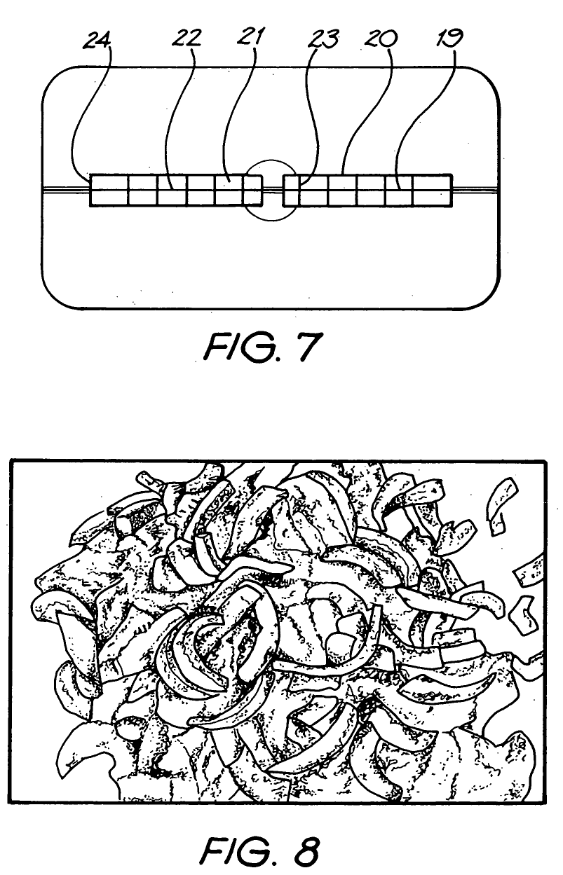

The resultant strips consequently strongly resemble ‘wafu steak’ strips, especially when included in a commercially canned food product with a starch-based gravy. The slices are shown in FIG. 7.

### EXAMPLE 2

### ‘Stir-Fry’ Strips

Where it is desired to switch to the production of a different product format, it is simply necessary to change the cutting device within the design parameters of the invention.

For the production of meat analogue pieces which resemble beef ‘stir-fry’ strips, a cutter should be configured as follows (and as shown in FIG. 6): a single blade which spans across the longer dimension of the orifice, effectively bisecting it in order to slice a 7 mm thick ribbon into two equal slices of 3.5 mm thickness, as above. As per Example 1, the application of the inventive method to cutting the extrudate dictates that at least one blade is arranged to span longitudinally across the longest dimension of the orifice, in a direction substantially parallel with the longer edge. As the requirement here is for a slightly thicker analogue, a single blade is used. To meet other aesthetic analogue sizing requirements there are also six blades which span across the shorter dimension of the orifice, effectively evenly dividing the ribbon into seven strips 10 mm wide.

The resultant strips consequently strongly resemble ‘stir fry’ strips, especially when included in a commercially canned food product with a starch-based gravy, or, when dried or formulated with humectants to preserve shelf life, when included in a dry packeted pet food mix. The slices are shown in FIG. 8.

The person skilled in the art will appreciate that, while the invention is ideal for use in relation to pet food manufacture, where ‘value-adding’ low-cost raw materials is crucial, this technology is equally applicable to wide range of human food applications.

The person skilled in the art will also appreciate that, while the above examples have primarily related to intermediate moisture extrusion, the inventive technology could equally be applied to low moisture extrusion, whether the results are to be included in dry packeted foods or canned foods, or any other appropriate application.

The person skilled in the art will also appreciate that, while the above examples have primarily related to a cutting device mounted at the exit of a cooling die, it could equally be contemplated that where a cooling die is used, the blade configuration could be mounted inside the cooling die. It would only be necessary that the cutting device be situated at a point where the internal grain is already formed, and where the extrudate is cooled sufficiently for the slices not to re-fuse together post-blade.

1. A method of producing a textured proteinaceous meat analogue, with an optimized fibrous appearance, from an extrudate which passes through a conduit of known cross-sectional shape, said method comprising the steps of:
determining a cutting profile for said extrudate, said profile including the making of a slice through the extrudate that is substantially co-linear with the longest axis of said cross-sectional shape; and
slicing through said extrudate, via one or more blades adapted to slice in a manner according to the above determined profile, in a direction substantially opposed to the direction of flow of the extrudate through, or exiting, said conduit.

2. The method of claim 1, wherein the cross-sectional shape of said conduit is substantially oblong, and wherein said cutting profile is determined such that at least one blade slices through the extrudate in an orientation that is substantially parallel with the longest dimension of said oblong shape.

3. The method of claim 2, wherein the cross-sectional shape of said conduit is substantially a rectangle having a long dimension greater than five times that of a short dimension, and wherein said cutting profile requires at least one blade to slice through the extrudate in a profile that is substantially parallel with the longer of said extrudate cross-sectional dimensions.

4. The method of claim 1, wherein the cross-sectional shape of said conduit is substantially circular in shape and wherein said cutting profile includes the making of at least one circular slice substantially concentric with said profile.

5. The method of claim 1, further including the step of cooling said extrudate prior to cutting.

6. The method of claim 5, wherein said extrudate is an internally textured proteinaceous meat analogue, having a final moisture content of greater than 30% by mass.

7. A cutting device for slicing a textured proteinaceous meat analogue, adapted to the cutting profile of claim 1.

8. A cutting device according to claim 7, said device being mounted inside said conduit.

9. A production facility for food products incorporating a cutting device according to claim 7.

10. A food product incorporating a textured proteinaceous meat analogue produced by a method according to claim 1.

11. (canceled)

12. (canceled)
